(19) United States
(12) Patent Application Publication
(10) Pub. No.: US 2018/0035461 A1
(43) Pub. Date: Feb. 1, 2018

(54) MEDIUM PROTECTING METHOD AND DEVICE FOR MU TRANSMISSION IN WIRELESS LAN

(71) Applicant: LG ELECTRONICS INC., Seoul (KR)

(72) Inventors: Suhwook KIM, Seoul (KR); Kiseon RYU, Seoul (KR); Jinyoung CHUN, Seoul (KR); Hangyu CHO, Seoul (KR)

(73) Assignee: LG ELECTRONICS INC., Seoul (KR)

(21) Appl. No.: 15/550,005

(22) PCT Filed: Jan. 22, 2016
(86) PCT No.: PCT/KR2016/000743

§ 371 Date: Aug. 9, 2017

Related U.S. Application Data
(60) Provisional application No. 62/114,592, filed on Feb. 11, 2015.

(51) Int. Cl. H04W 74/08

(52) U.S. Cl. CPC H04W 74/0816; H04W 84/12

(57) ABSTRACT

Disclosed are a medium protection-based method and device for MU transmission in a wireless LAN. The medium protecting method for MU transmission in a wireless LAN can comprise the steps of: receiving, by an STA, an RTS frame transmitted on the basis of DL MU transmission by an AP; and determining, by the STA, whether to configure an NAV on the basis of an RA field of the RTS frame, wherein if the RTS frame is an MU RTS frame for acquiring MU TXOP, the RA field includes an RA control field and a plurality of RA simple identification fields, the MU TXOP indicates a time resource having a transmission right for DL MU transmission of downlink data, the RA control field includes information for indicating that the RTS frame is an MU RTS frame transmitted to acquire the MU TXOP, and each of the plurality of RA simple identification fields can include identification information of each of the plurality of STAs.

### BACKGROUND OF THE INVENTION

### Field of the Invention

The present invention relates to wireless communication, and more particularly, a method and a device for protecting a medium for multi-user (MU) transmission in a wireless LAN.

### Related Art

Discussion for a next-generation wireless local area network (WLAN) is in progress. In the next-generation WLAN, an object is to 1) improve an institute of electronic and electronics engineers (IEEE) 802.11 physical (PHY) layer and a medium access control (MAC) layer in bands of 2.4 GHz and 5 GHz, 2) increase spectrum efficiency and area throughput, 3) improve performance in actual indoor and outdoor environments such as an environment in which an interference source exists, a dense heterogeneous network environment, and an environment in which a high user load exists, and the like.

An environment which is primarily considered in the next-generation WLAN is a dense environment in which access points (APs) and stations (STAs) are a lot and under the dense environment, improvement of the spectrum efficiency and the area throughput is discussed. Further, in the next-generation WLAN, in addition to the indoor environment, in the outdoor environment which is not considerably considered in the existing WLAN, substantial performance improvement is concerned.

In detail, scenarios such as wireless office, smart home, stadium, Hotspot, and building/apartment are largely concerned in the next-generation WLAN and discussion about improvement of system performance in a dense environment in which the APs and the STAs are a lot is performed based on the corresponding scenarios.

In the next-generation WLAN, improvement of system performance in an overlapping basic service set (OBSS) environment and improvement of outdoor environment performance, and cellular offloading are anticipated to be actively discussed rather than improvement of single link performance in one basic service set (BSS). Directionality of the next-generation means that the next-generation WLAN gradually has a technical scope similar to mobile communication. When a situation is considered, in which the mobile communication and the WLAN technology have been discussed in a small cell and a direct-to-direct (D2D) communication area in recent years, technical and business convergence of the next-generation WLAN and the mobile communication is predicted to be further active.

### SUMMARY OF THE INVENTION

The present invention provides a medium protection method for MU transmission in a wireless LAN.

The present invention also provides a medium protection device for MU transmission in a wireless LAN.

In an aspect, a medium protecting method for MU transmission in a wireless LAN is provided. The method includes: receiving, by an STA, an RTS frame transmitted on the basis of DL MU transmission by an AP; and determining, by the STA, whether to configure an NAV on the basis of an RA field of the RTS frame, wherein if the RTS frame is an MU RTS frame for acquiring MU TXOP, the RA field includes an RA control field and a plurality of RA simple identification fields, the MU TXOP indicates a time resource having a transmission right for DL MU transmission of downlink data, the RA control field includes information for indicating that the RTS frame is an MU RTS frame transmitted to acquire the MU TXOP, and each of the plurality of RA simple identification fields can include identification information of each of the plurality of STAs.

In another aspect, a station (STA) for performing medium protection for multi-user (MU) transmission in a wireless LAN is provided. The station includes: a radio frequency (RF) unit transmitting and receiving a radio signal; and a processor operatively coupled with the RF unit, and the processor is implemented to receive a request to send (RTS) frame transmitted on the basis of downlink (DL) multi-user (MU) transmission by an AP, and determine whether to configure a network allocation vector (NAV) on the basis of a receiver address (RA) field of the RTS frame, if the RTS frame is an MU RTS frame for acquiring transmission opportunity (MU TXOP), the RA field includes an RA control field and a plurality of RA simple identification fields, the MU TXOP indicates a time resource having a transmission right for DL MU transmission of downlink data, the RA control field includes information for indicating that the RTS frame is an MU RTS frame transmitted to acquire the MU TXOP, and each of the plurality of RA simple identification fields can include identification information of each of the plurality of STAs.

A multi-user (MU) transmission opportunity (TXOP) for MU transmission can be effectively protected.

### BRIEF DESCRIPTION OF THE DRAWINGS

FIG. 1 is a conceptual view illustrating the structure of a wireless local area network (WLAN).

FIG. 2 is a diagram illustrating a hierarchical architecture of a wireless LAN system supported by IEEE 802.11.

FIG. 3 is a conceptual view illustrating an issue which may occur when an STA senses a medium.

FIG. 4 is a conceptual view illustrating transmission and reception methods of an RTS frame and a CTS frame in order to solve a hidden node issue and an exposed node issue.

FIG. 5 is a conceptual view illustrating a hidden node according to an embodiment of the present invention.

FIG. 6 is a conceptual view illustrating a format of an MU RTS frame according to an embodiment of the present invention.

FIG. 7 is a conceptual view illustrating a transmission method of an MU RTS frame/MU CTS frame according to an embodiment of the present invention.

FIG. 8 is a conceptual view illustrating a transmission method of an MU RTS frame/MU CTS frame according to an embodiment of the present invention.

FIG. 9 is a conceptual view illustrating a format of a DL MU PPDU according to an embodiment of the present invention.

FIG. 10 is a conceptual view illustrating a format of a UL MU PPDU according to an embodiment of the present invention.

FIG. 11 is a block diagram illustrating a wireless apparatus to which an embodiment of the present invention can be applied.

### DESCRIPTION OF EXEMPLARY EMBODIMENTS

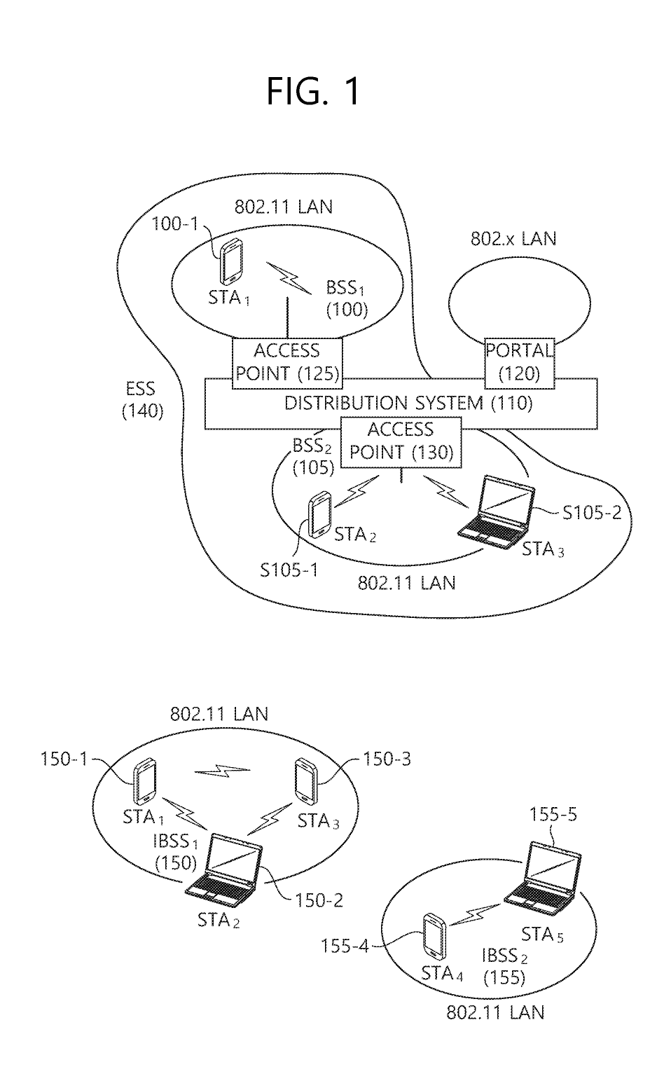

FIG. 1 is a conceptual view illustrating the structure of a wireless local area network (WLAN).

An upper part of FIG. 1 illustrates the structure of an infrastructure basic service set (BSS) of institute of electrical and electronic engineers (IEEE) 802.11.

Referring the upper part of FIG. 1, the wireless LAN system may include one or more infrastructure BSSs 100 and 105 (hereinafter, referred to as BSS). The BSSs 100 and 105 as a set of an AP and an STA such as an access point (AP) 125 and a station (STA1) 100-1 which are successfully synchronized to communicate with each other are not concepts indicating a specific region. The BSS 105 may include one or more STAs 105-1 and 105-2 which may be joined to one AP 130.

The BSS may include at least one STA, APs providing a distribution service, and a distribution system (DS) 110 connecting multiple APs.

The distribution system 110 may implement an extended service set (ESS) 140 extended by connecting the multiple BSSs 100 and 105. The ESS 140 may be used as a term indicating one network configured by connecting one or more APs 125 or 230 through the distribution system 110. The AP included in one ESS 140 may have the same service set identification (SSID).

A portal 120 may serve as a bridge which connects the wireless LAN network (IEEE 802.11) and another network (e.g., 802.X).

In the BSS illustrated in the upper part of FIG. 1, a network between the APs 125 and 130 and a network between the APs 125 and 130 and the STAs 100-1, 105-1, and 105-2 may be implemented. However, the network is configured even between the STAs without the APs 125 and 130 to perform communication. A network in which the communication is performed by configuring the network even between the STAs without the APs 125 and 130 is defined as an Ad-Hoc network or an independent basic service set (IBSS).

A lower part of FIG. 1 illustrates a conceptual view illustrating the IBSS.

Referring to the lower part of FIG. 1, the IBSS is a BSS that operates in an Ad-Hoc mode. Since the IBSS does not include the access point (AP), a centralized management entity that performs a management function at the center does not exist. That is, in the IBSS, STAs 150-1, 150-2, 150-3, 155-4, and 155-5 are managed by a distributed manner. In the IBSS, all STAs 150-1, 150-2, 150-3, 155-4, and 155-5 may be constituted by movable STAs and are not permitted to access the DS to constitute a self-contained network.

The STA as a predetermined functional medium that includes a medium access control (MAC) that follows a regulation of an Institute of Electrical and Electronics Engineers (IEEE) 802.11 standard and a physical layer interface for a radio medium may be used as a meaning including all of the APs and the non-AP stations (STAs).

The STA may be called various a name such as a mobile terminal, a wireless device, a wireless transmit/receive unit (WTRU), user equipment (UE), a mobile station (MS), a mobile subscriber unit, or just a user.

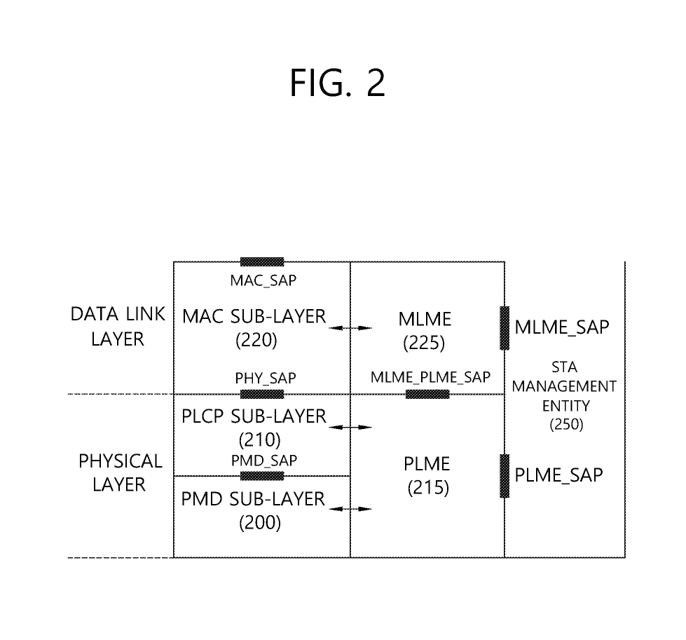

FIG. 2 is a diagram illustrating a hierarchical architecture of a wireless LAN system supported by IEEE 802.11.

In FIG. 2, a hierarchical (PHY) architecture of the wireless LAN system is conceptually illustrated.

The hierarchical architecture of the wireless system may include a medium access control (MAC) sublayer 220, a physical layer convergence procedure (PLCP) sublayer 210, and a physical medium dependent (PMD) sublayer 200. The PLCP sublayer 210 is implemented so that the MAC sublayer 220 operates with minimal dependency on the PMD sublayer 200. The PMD sublayer 200 may serve as a transmission interface for transmitting/receiving data among a plurality of STAs.

The MAC sublayer 220, the PLC layer 210, and the PMD sublayer 200 may conceptually include a management entity.

The management entity of the MAC sublayer 220 is referred to as an MAC layer management entity 225 and the management entity of the physical layer is referred to as a PHY layer management entity (PLME) 215. The management entities may provide an interface in which a hierarchical management operation is performed. The PLME 215 is connection with the MLME 225 to perform a management operation of the PLCP sublayer 210 and the PMD sublayer 200 and the MLME 225 is also connected with the PLME 215 to perform the management operation of the MAC sublayer 220.

An STA management entity (SME) 250 may be present in order to perform a correct MAC layer operation. The SME 250 may operate as a component independent from the layer. The MLME, the PLME and the SME may transmit and receive information to and from each other based on primitive.

The operation in each sublayer will be described below in brief. The PLCP sublayer 110 transfers an MAC protocol data unit (MPDU) received from the MAC sublayer 220 to the PMD sublayer 200 or transfers a frame received from the PMD sublayer 200 to the MAC sublayer 220 according to an instruction of an MAC layer between the MAC sublayer 220 and the PMD sublayer 200. The PMD sublayer 200 as a PLCP lower layer may perform transmission and reception of data between the plurality of STAs through a radio medium. The MAC protocol data unit (MPDU) transferred by the MAC sublayer 220 is referred to as a physical service data unit (PSDU) in the PLCP sublayer 210. The MPDU is similar to the PSDU, but when an aggregated MPDU acquired by aggregating a plurality of MPDUs is transferred, individual MPDUs and PSDUs may be different from each other.

The PLCP sublayer 210 adds an additional field including information required by a physical layer transceiver while receiving the PSDU from the MAC sublayer 220 and transferring the received PSDU to the PMD sublayer 200. In this case, the added field may include a PLCP preamble, a PLCP header, tail bits required for returning a convolution encoder to a zero state, and the like in the PSDU. The PLCP preamble may serve to allow a receiver to prepare for a synchronization function and antenna diversity before the PSDU is transmitted. A data field may include padding bits, a service field including a bit sequence for initializing a scrambler, and a coded sequence acquired by encoding the bit sequence to which the tail bits are added in the PSDU. In this case, an encoding method may be selected as one of binary convolutional coding (BCC) encoding and low density parity check (LDPC) encoding supported by the STA that receives the PPDU. The PLCP header may include a field including information on the PLCP protocol data unit (PPDU) to be transmitted.

The PLCP sublayer 210 generates the PLCP protocol data unit (PPDU) by adding the aforementioned field to the PSDU and transmits the generated PPDU to a receiving station through the PDM sublayer 200 and the receiving station acquires and restores information required for restoring data from the PLCP preamble and the PLCP header by receiving the PPDU.

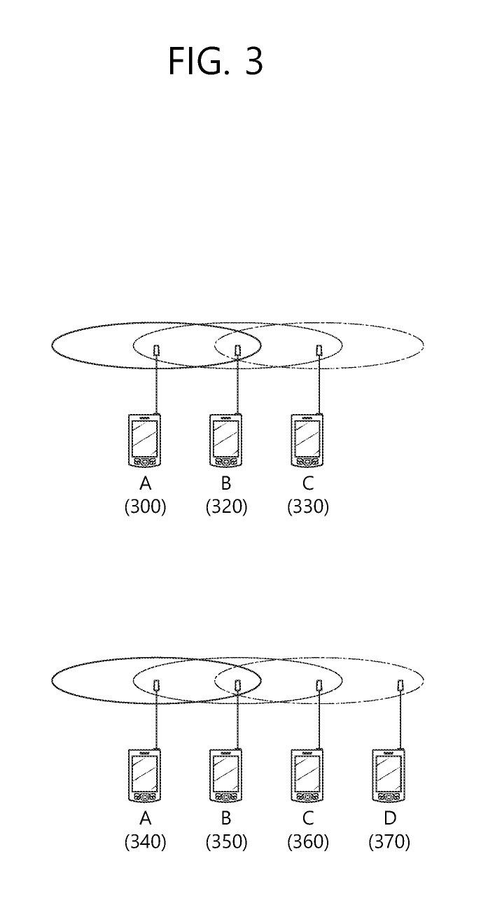

FIG. 3 is a conceptual view illustrating an issue which may occur when an STA senses a medium.

An upper end of FIG. 3 illustrates a hidden nose issue and a lower end of FIG. 3 illustrates an exposed node issue.

On the upper end of FIG. 3, assumed is a case where STA A 300 and STA B 320 transmit and receive current data and STA C 330 has data to be transmitted to STA B 320. When the data is transmitted and received between STA A 300 and STA B 320, a specific channel may be busy. However, when STA C 330 carrier-senses the media before transmitting the data to the STA B 320 due to transmission coverage, there is a possibility that the STA C 330 will determine that the media for transmitting the data to the STA B 320 is idle. When the STA C 330 determines that the medium is idle, the data may be transmitted from the STA C 330 to the STA B 320. Consequently, since the STA B 320 simultaneously receives information of the STA A 300 and the STA C 330, a collision of the data occurs. In this case, the STA A 300 may be referred to as a hidden node in terms of the STA C 330.

At the lower end of FIG. 3, the case where the STA B 350 transmits the data to the STA A 340 is assumed. When the STA C 360 intends to transmit the data to STA D 370, the STA C 360 may perform carrier sensing in order to find whether the channel is busy. Since the STA B 350 transmits the information to the STA A 340, the STA C 360 may sense that the medium is busy due to the transmission coverage of the STA B 350. In this case, even though the STA C 360 intends to transmit the data to the STA D 370, a state in which the medium is busy is sensed, and as a result, the data may not be transmitted to the STA D 370. A situation occurs, in which the STA C 360 needs to unnecessarily wait until it is sensed that the medium is idle after the STA B 350 completes transmitting the data to the STA A 340. That is, even though the STA A 340 is out of a carrier sensing range of the STA C 360, the STA A 340 may prevent the STA C 360 from transmitting the data. In this case, the STA C 360 becomes the exposed node of the STA B 350.

In order to solve the exposed node issue disclosed at the upper end of FIG. 3 and exposed node issue disclosed at the lower end of FIG. 3, it may be sensed whether the medium is busy by using the RTS frame and the CTS frame in the WLAN.

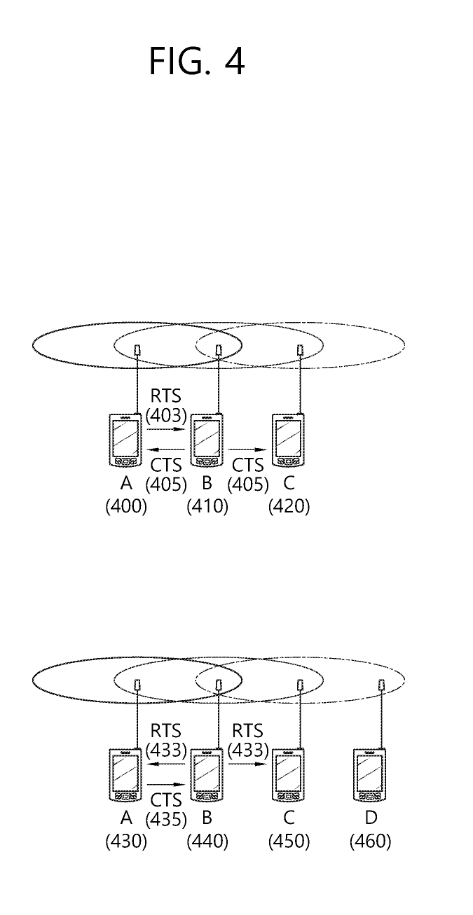

FIG. 4 is a conceptual view illustrating transmission and reception methods of an RTS frame and a CTS frame in order to solve a hidden node issue and an exposed node issue.

Referring to FIG. 4, short signaling frames such as the request to send (RTS) frame and the clear to send (CTS) frame may be used in order to solve the hidden node issue and the exposed node problem. It may be overheard whether the data is transmitted and received among neighboring STAs based on the RTS frame and the CTS frame.

The upper end of FIG. 4 illustrates a method for transmitting an RTS frame 403 and a CTS frame 405 in order to solve the hidden node issue.

Assuming that both STA A 400 and STA C 420 intend to transmit data to STA B 410, when the STA A 400 sends the RTS frame 403 to the STA B 410, the STA B 410 may transmit the CTS frame 405 to both the STA A 400 and the STA C 420 on the periphery thereof. The STA C 420 that receives the CTS frame 405 from the STA B 410 may acquire information indicating that the STA A 400 and the STA B 410 are transmitting the data. Further, the RTS frame 403 and the CTS frame 405 includes a duration field including information on a period when a radio channel is busy to configure a network allocation vector during a predetermined period so as to prevent the STA C 420 from using a channel.

The STA C 420 waits until terminating transmission and reception of the data between the STA A 400 and the STA B 410 to prevent the collision at the time of transmitting the data to the STA B 410.

The lower end of FIG. 4 illustrates a method for transmitting an RTS frame 433 and a CTS frame 435 in order to solve the exposed node issue.

The STA C 450 overhears transmission of the RTS frame 433 and the CTS frame 435 of the STA A 430 and the STA B 440 to know that the collision does not occur even though the STA C 450 transmits the data to another STA D 460. That is, the STA B 440 transmits the RTS frame 433 to all neighboring terminals and transmits the CTS frame 435 only to the STA A 430 which actually transmits the data. Since the STA C 450 receives only the RTS frame 433 and is not enabled to receive the CTS frame 435, it can be seen that the STA A 430 is outside the carrier sensing range. Therefore, the STA C 450 may transmit the data to the STA D 460.

An RTS frame format and a CTS frame format are disclosed in “IEEE Standard for Information Technology Telecommunications and information exchange between systems Local and metropolitan area networks Specific requirements Part 11: 8.3.1.2 RTS frame format and 8.3.1.3 CTS frame format of Wireless LAN Medium Access Control (MAC) and Physical Layer (PHY) Specifications which is IEEE Draft P802.11-REVmb™/D12 opened in November 2011.

Hereinafter, in the embodiment of the present invention, data (alternatively, frame) transmitted from the AP to the STA may be expressed as a term called downlink data (alternatively, downlink frame) and data (alternatively, frame) transmitted from the STA to the AP may be expressed as a term called uplink data (alternatively, uplink frame). Further, transmission from the AP to the STA may be expressed as a term called downlink transmission and transmission from the STA to the AP may be expressed as a term called uplink transmission. In addition, the PHY protocol data unit (PPDU), the frame, and the data transmitted through the downlink transmission may be expressed as terms called a downlink PPDU, a downlink frame, and downlink data, respectively. Further, the PPDU, the frame, and the data transmitted through the uplink transmission may be expressed as terms called an uplink PPDU, an uplink frame, and uplink data, respectively.

The PPDU may be a data unit including the PPDU header and a physical layer service data unit (alternatively, MAC protocol data unit (MPDU)). The PPDU header may include a PHY header and a PHY preamble and the PSDU (alternatively, MPDU) may be a data unit including the frame (alternatively, an information unit of an MAC layer) or indicating the frame. The PHY header may be expressed as a physical layer convergence protocol (PLCP) header as another term and the PHY preamble may be expressed as a PLCP preamble as another term.

In the wireless LAN system in the related art, a whole bandwidth is used for the downlink transmission to one STA and the uplink transmission of one STA based on single (SU)-orthogonal frequency division multiplexing (OFDM) transmission. Further, in the wireless LAN system in the related art, the AP may perform downlink (DL) multi-user (MU) transmission based on MU multiple input multiple output (MIMO) and the transmission may be expressed as a term called DL MU MIMO transmission.

In the wireless LAN system in the related art, which does not support MU orthogonal frequency division multiple access (OFDMA) transmission, a method for allocating multi-channels is used for allocating a wider bandwidth (e.g., 200 MHz-over bandwidth) to one terminal. The multi-channels may include a plurality of 20-MHz channels when one channel unit is 20 MHz. In the multi-channel allocating method, a primary channel rule is used for allocating the wider bandwidth to the terminal. When the primary channel rule is used, there is a restriction for allocating the wider bandwidth to the terminal. In detail, according to the primary channel rule, when a secondary channel adjacent to a primary channel is used in an overlapped BSS (OBSS) and ‘busy’, the STA may not use remaining channels other than the primary channel Therefore, since the STA may transmit the frame only to the primary channel, the STA is restricted in transmitting the frame through the multi-channels. That is, the primary channel rule used for allocating the multi-channels in the wireless LAN system in the related art may become a large restriction in acquiring a high throughput by operating the wider bandwidth in a current wireless LAN environment in which the OBSS is not small.

In order to solve the problem, the embodiment of the present invention discloses a wireless LAN system that supports MU orthogonal frequency division multiple access (OFDMA) technology. When the OFDMA technology is used, not one terminal but multiple terminals may simultaneously use the multi-channels without the restriction by the primary channel rule. Therefore, the wider bandwidth is enabled to be operated to enhance efficiency of operating a radio resource.

In detail, in the wireless LAN system according to the embodiment of the present invention, the AP may perform the DL MU transmission based on the OFDMA and the transmission may be expressed as a term called DL MU OFDMA transmission. When the DL MU OFDMA transmission is performed, the AP may transmit the downlink data (alternatively, downlink frame and downlink PPDU) to each of a plurality of STAs through each of a plurality of frequency resources on an overlapped time resource. A plurality of frequency resources may be a plurality of subbands (alternatively, sub channels) or a plurality of resource units (RUs) (e.g., a basic tone unit (BTU) and a small tone unit (STU)). The DL MU OFDMA transmission may be used together with the DL MU MIMO transmission. For example, the DL MU MIMO transmission based on a plurality of space-time streams (alternatively, spatial streams) may be performed on a specific subband (alternatively, sub channel) or resource unit allocated for the DL MU OFDMA transmission.

The BTU exemplified as the resource unit as above may be a relatively larger size resource unit than the STU. For example, the BTU may be defined with sizes including 52 tones, 56 tones, 114 tones, and the like. The BTU may be defined as the same size regardless of sizes (e.g., 20 MHz, 40 MHz, 80 MHz, 160 MHz, and the like) of available bandwidths or defined as a size which varies dependently on the size of the available bandwidth. For example, the size of the BTU may be defined as a relatively larger value as the size of the available bandwidth increases. Tone may be interpreted as the same meaning as a subcarrier. The STU may be a relatively smaller size resource unit than the BTU. For example, the STU may be defined with the size of 26 tones.

Further, in the wireless LAN system according to the embodiment of the present invention, uplink multi-user transmission in which the plurality of STAs transmits data to the AP in the same time resource may be supported. The uplink transmission on the time resource overlapped by the plurality of respective STAs may be performed in a frequency domain or a spatial domain. When the uplink transmission by each of the plurality of STAs is performed in the frequency domain, different frequency resources may be allocated to the plurality of STAs, respectively as the uplink transmission resource. The different frequency resources may be different subbands (alternatively, sub channels) or different resource units (RUs) (e.g., the basic tone unit (BTU) and the small tone unit (STU)). The plurality of respective STAs may transmit the uplink data to the AP through different allocated frequency resources. The transmission method through the different frequency resources may be expressed as the term called a UL MU OFDMA transmission method. When the uplink transmissions by each of the plurality of STAs is performed on the spatial domain, different time-space streams (alternatively, spatial streams) may be allocated to the plurality of respective STAs and the plurality of respective STAs may transmit the uplink data to the AP through different time-space streams. The transmission method through the different spatial streams may be expressed as the term called a UL MU MIMO transmission method. The UL MU OFDMA transmission and the UL MU MIMO transmission may be together performed. For example, the UL MU MIMO transmission based on the plurality of time-space streams (alternatively, spatial streams) may be performed on a specific subband (alternatively, sub channel) or resource unit allocated for the UL MU OFDMA transmission.

A time-frequency structure assumed in the wireless LAN system according to the embodiment of the present invention may be exemplarily as follows.

A fast fourier transform (FFT) size/inverse fast fourier transform (IFFT) size may be defined to be N times (N is a natural number, e.g., N=4) as large as an FFT/IFFT size used in the wireless LAN system in the related art. For example, 256 FFT/IFFT may be applied to the bandwidth of 20 MHz, 512 FFT/IFFT may be applied to the bandwidth of 40 MHz, 1024 FFT/IFFT may be applied to the bandwidth of 80 MHz, and 2048 FFT/IFFT may be applied to a continuous 160-MHz or discontinuous 160-MHz bandwidth.

A subcarrier spacing may have a size which is 1/N times (N is the natural number, e.g., when N=4, 78.125 kHz) as large as the size of the subcarrier spacing used in the wireless LAN system in the related art.

An IDFT/DFT length (alternatively, effective symbol length) based on inverse discrete fourier transform (IDFT)/discrete fourier transform (DFT) (alternatively, FFT/IFFT) may be N times as large as the IDFT/DFT length in the wireless LAN system in the related art. For example, when the IDFT/DFT length is 3.2 μs and N=4 in the wireless LAN system in the related art, the IDFT/DFT length may be 3.2 μs*4(=12.8 μs) in the wireless LAN system according to the embodiment of the present invention.

The length of the OFDM symbol may be a value acquired by adding the length of a guard interval (GI) to the IDFT/DFT length. The length of the GI may be various values such as 0.4 μs, 0.8 μs, 1.6 μs, 2.4 μs, and 3.2 μs.

The MU transmission may be important technology for enhancing efficiency of the wireless LAN system. MU TXOP protection for protecting the medium while performing the MUL transmission may be an important element for guaranteeing performance of the MU transmission. MU TXOP may mean a medium access right (alternatively, time) allocated for the MU transmission.

Transmission and reception of the RTS frame/CTS frame used for current TXOP protection are defined to be suitable for SU transmission.

A hidden terminal issue (alternatively, hidden node issue) may exert a larger influence in an environment in which the STA are concentrated. However, an exchange of the current RTS/CTS frame may be insufficient in supporting the MU transmission. If the MU TXOP is not protected from a hidden node (alternatively, hidden terminal), the efficiency of the MU transmission may be reduced.

In the embodiment of the present invention, an MU TXOP protection procedure is disclosed, which is based on a changed RTS frame/CTS frame format and a changed RTS frame/CTS frame for protecting the MU TXOP for the MU transmission.

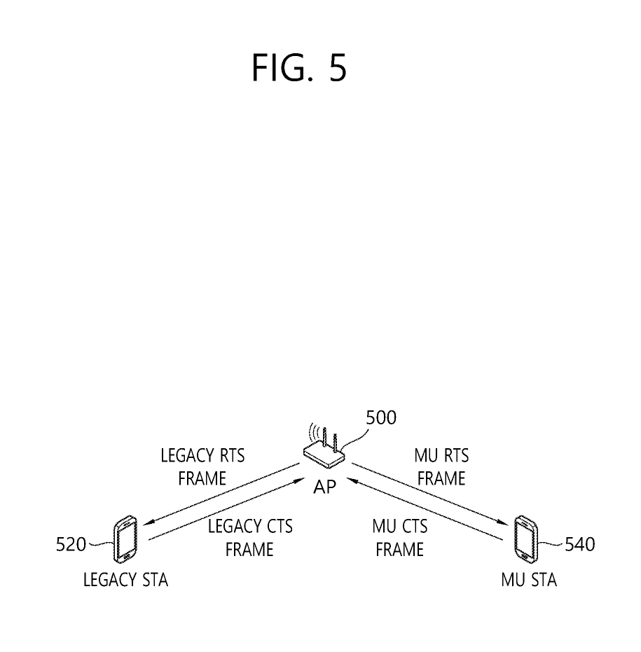

FIG. 5 is a conceptual view illustrating a hidden node according to an embodiment of the present invention.

Referring to FIG. 5, two types of hidden nodes (alternatively, hidden terminals) are disclosed.

First, the hidden node may be legacy STA 520. The legacy STA 520 may be an STA that supports the previous wireless LAN standard (e.g., IEEE802.11n, IEEE802.11ac).

When the hidden node is the legacy STA 520, the hidden node may decode only an RTS frame/CTS frame (that is, the RTS frame/CTS frame defined in the wireless LAN system in the related art) of a legacy format. Therefore, the change of the format of the RTS frame/CTS frame for the MU transmission may be limitative.

Alternatively, the hidden node may be an STA 540 according to the embodiment of the present invention, which supports the DL MU transmission/UL MU transmission. Hereinafter, a term called MU STA 540 means not a legacy STA but an STA that supports the DL MU transmission/UL MU transmission according to the embodiment of the present invention. If not separately mentioned, the MU STA 540 may be interpreted as an MU non-AP STA or MU AP.

When the hidden node is the MU STA 540 that supports the DL MU transmission/UL MU transmission, the hidden node may decode an MU RTS frame of an MU transmission format transmitted based on DL MU OFDMA/DL MU MIMO defined as a new type and transmit an MU CTS frame of an MU transmission format based on UL MU OFDMA/UL MU MIMO.

An AP (alternatively, MU AP) 500 that intends to transmit the frame through the medium may not know whether a type of the hidden node is the legacy STA 520 or the MU STA 540. Therefore, under the assumption that the legacy STA 520 is present, an acquisition procedure of the MU TXOP needs to be performed.

The legacy STA 520 decodes a legacy RTS frame and a legacy CTS frame. Therefore, the format of the PPDU header/the format of the MAC header need not be changed, which transfers the legacy RTS frame and the legacy CTS frame in order to protect the MU TXOP from the legacy STA 520. According to the embodiment of the present invention, an RTS frame and a CTS frame in which a field of a new MAC header is not added and an RA field is re-defined are disclosed. Hereinafter, the RTS frame according to the embodiment of the present invention may be expressed as a term called MU RTS frame and the CTS frame may be expressed as a term called MU CTS frame and the RTS frame in the related art may be expressed as a term called legacy RTS frame and the CTS frame in the related art may be expressed as a term called legacy CTS frame.

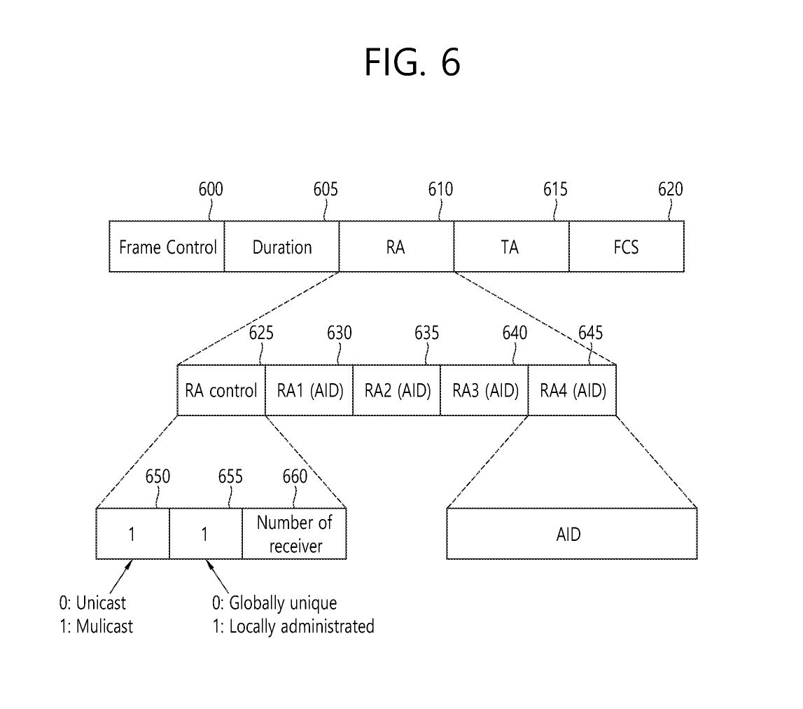

FIG. 6 is a conceptual view illustrating a format of an MU RTS frame according to an embodiment of the present invention.

In FIG. 6, the MU RTS frame having the receiver address (RA) field of a changed format is disclosed. The MU TXOP may be protected based on the RA filed of the changed format of the MU RTS frame.

Referring to FIG. 6, the MU RTS frame may include a frame control field 600, a duration field 605, a receiver address (RA) field 610, a transmitter address (TA) field 615, and a frame check sequence (FCS) 620.

The frame control field 600 may include information on a frame type/sub type, information indicating whether the frame is retransmitted, power management information, and the like.

The duration field 605 may include information on the time (the time for a data transmitting or receiving procedure triggered based on the MU RTS frame) for transmitting and receiving procedures of frames including the MU CTS frame, a data frame, a block acknowledgement (ACK) frame, and the like after transmitting the MU RTS frame. As another expression, the duration field may include information on a duration of the MU TXOP.

The RA field 610 may include identification information of the MU STA that receives the MU RTS frame.

According to the embodiment of the present invention, the RA field 610 may include an RA control field 625, an RA1 (AID) field 630, an RA2 (AID) field 635, an RA3 (AID) field 640, and an RA4 (AID) field 645.

The RA control field 625 may include transmission type information 650, identifier type information 655, and receiver number information 660.

The transmission type information 650 may indicate whether a transmission type is unicast or multicast.

The identifier type information 655 may indicate whether an identifier type is globally unique or locally administrated.

The RA field in the related art may include an MAC address of a reception STA that receives the MU RTS frame and first two bits of the RA field in the related art may be ‘0’ indicating that the transmission type is unicast and ‘0’ indicating that the identifier type is globally unique. That is, since the legacy RTS frame is not transmitted based on the multicast but the globally unique identifier type is used in the wireless LAN system in the related art, two bits corresponding to most significant bit (MSB) of the RA field in the related art and MSB-1 are fixedly to ‘00’.

In the case of the RA control field 625 of the RA field 610 of the MU RTS frame according to the embodiment of the present invention, the transmission type information 650 may be set to ‘1’ and the identifier type information 655 may be set to ‘1’. That is, two bits corresponding to the MSB and the MSB-1 of the RA field 610 of the RTS frame according to the embodiment of the present invention may be set to ‘11’.

Since two bits corresponding to the MSB and the MSB-1 of the RA field 610 are not ‘00’, the legacy STA that receives the MU RTS frame in which two bits corresponding to the MSB and the MSB-1 of the RA field 610 are set to ‘11’ may determine that the legacy STA is not the reception STA of the RTS frame. The legacy STA may configure a network allocation vector (NAV) during the MU TXOP duration indicated based on the duration field 605. During the duration set as the NAV, a channel access may be restricted.

Since two bits corresponding to the MSB and the MSB-1 of the RA field 610 are ‘11’, the MU STA that receives the MU RTS frame in which two bits corresponding to the MSB and the MSB-1 are set to ‘11’ may determine that the received RTS frame is the MU RTS frame for the MU transmission. The MU STA decodes the RA1 (AID) field 630, the RA2 (AID) field 635, the RA3 (AID) field 640, and the RA4 (AID) field 645 to additionally verify whether the MU STA is the reception STA of the RTS frame.

In detail, the MU AP sets a plurality of MU STAs as the reception STA (alternatively, a target STA) to transmit the MU RTS frame. The MU RTS frame may be received even by other MU STA and STA in addition to the plurality of MU STAs which is the reception STA (alternatively, target STA) of the MU RTS frame. The plurality of MU STAs which is the reception STA of the MU RTS frame may be transmitted as a response to the MU RTS frame. On the contrary, other MU STA/STA other than the reception STA of the MU RTS frame may configure the NAV.

Each of the RA1 (AID) field 630, the RA2 (AID) field 635, the RA3 (AID) field 640, and the RA4 (AID) field 645 may include identification information (e.g., association identifier (AID) of a plurality of reception STAs that will receive the MU RTS frame.

As another expression, each of the RA1 (AID) field 630, the RA2 (AID) field 635, the RA3 (AID) field 640, and the RA4 (AID) field 645 may include identification information of each of a plurality of MU STAs that will receive the MU CTS frame as the response to the MU RTS frame when the MU AP transmits the MU RTS frame.

As yet another expression, each of the RA1 (AID) field 630, the RA2 (AID) field 635, the RA3 (AID) field 640, and the RA4 (AID) field 645 may include identification information of each of a plurality of MU STAs that will receive a plurality of data frames to be transmitted based on the DL MU transmission after the MU AP transmits the MU RTS frame.

In the case of each of the RA1 (AID) field 630 to the RA4 (AID) field 645, different numbers of RA (AID) fields may be included in the RA field as an example for a plurality of RA (AID) fields.

The MU RTS frame may be transmitted while being duplicated with different channels (alternatively, resource units) or different MU RTS frames may be transmitted in different channels (alternatively, resource units).

The MU CTS frame may have the same format as the legacy CTS frame in the related art.

The STA operates according to the following steps to determine whether to configure the NAV.

The STA may receive the RTS frame transmitted based on the DL MU transmission by the AP and the STA may determine whether to configure the NAV based on the RA field of the RTS frame. When the RTS frame is the MU RTS frame acquiring the MU TXOP, the RA field may include the RA control field and a plurality of RA simple identification fields. The MU TXOP may indicate the time resource having a transmission right for the downlink multi-user (DL MU) transmission of the downlink data.

The RA control field may include information indicating that the RTS frame is the MU RTS frame transmitted for acquiring the MU TXOP and each of the plurality of RA simple identification fields may include the identification information of each of the plurality of STAs. The RA control field may include the transmission type information, the identifier type information, and the reception STA number information and the transmission type information may indicate whether the transmission type of the frame is unicast or multicast. The identifier type information may indicate whether the identifier type is globally unique or locally administrated and the reception STA number information may include information on the number of the plurality of STAs.

When a value of the transmission type information is set to a first value and a value of the identifier type information is set to a second value, it may be indicated that the RTS frame is the MU RTS frame.

When the STA is the legacy STA that does not support the MU transmission, the value of the transmission type information is set to the first value, and the value of the identifier type information is set to the second value, the STA may configure the NAV. When the STA is the MU STA that supports the MU transmission, the value of the transmission type information is set to the first value, the value of the identifier type information is set to the second value, and the plurality of RS simple identification fields indicates the STA, the STA may transmit the MU CTS frame for protecting the MU TXOP to the AP based on the UL MU transmission without configuring the NAV.

The STA may receive the downlink frame transmitted based on the DL MU transmission by the AP after transmitting the MU CTS frame and the STA may transmit a block acknowledgement (BA) frame to the AP based on the UL MU transmission as the response to the downlink frame.

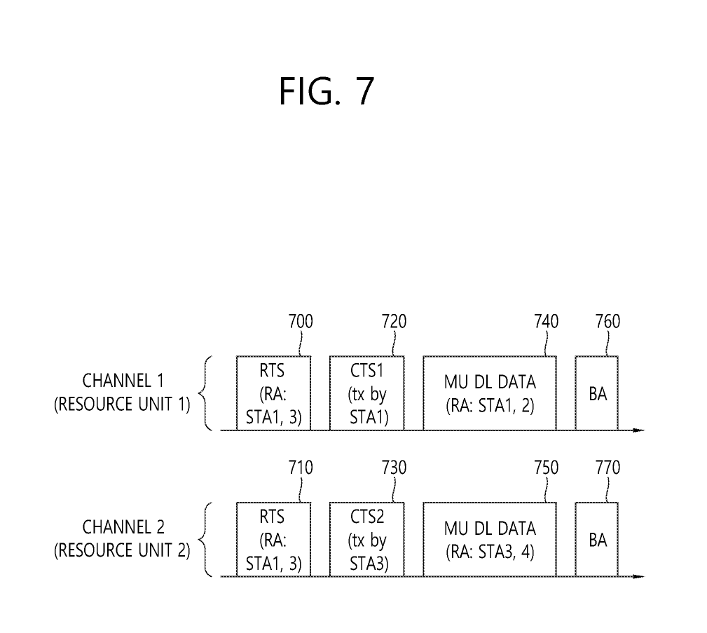

FIG. 7 is a conceptual view illustrating a transmission method of an MU RTS frame/MU CTS frame according to an embodiment of the present invention.

In FIG. 7, a method for protecting the MU TXOP based on transmission of the MU RTS frame of the MU AP and transmission of the MU CTS frame of the MU STA is disclosed. Hereinafter, the channel may be interpreted even as the resource unit. In detail, channel 1 may be interpreted as resource unit 1, channel 2, and resource unit 2.

Referring to FIG. 7, the AP may transmit a DL MU PPDU 740 including DL frame 1 and DL frame 2 to each of MU STA 1 and MU STA 2 through channel 1 based on the DL MU transmission and transmit a DL MU PPDU 750 including DL frame 3 and DL frame 4 to each of MU STA 3 and MU STA 4 through channel 2 based on the DL MU transmission. Although discontinuously expressed for easy description, the DL MU PPDUs 740 and 750 transmitted through channels 1 and 2 may be one DL MU PPDU transmitted on a continuous frequency resource.

In order to acquire the MU TXOP for transmitting the DL MU PPDU including DL frame 1 to DL frame 4, the MU AP may transmit MU RTS frame 1 700 through channel 1 and transmit MU RTS frame 2 710 through channel 2 based on the DL MU transmission. MU RTS frame 1 700 and MU RTS frame 2 710 may be transferred to a plurality of STAs through one DL MU PPDU on channel 1 and channel 2.

The plurality of MU RTS frames 700 and 710 transmitted through a plurality of respective channels may be a duplicate format. That is, the plurality of MU RTS frames 700 and 710 transmitted through the plurality of respective channels may be a format having the same data.

Further, with respect to the MU RTS frames 700 and 710, only one (alternatively, specific) MU STA among the plurality of MU STAs that will receive the plurality of DL frames in the plurality of respective channels may be set as the reception STA. As another expression, a specific MU STA may be set as a representative among the plurality of MU STAs that will receive the DL frames through the plurality of respective channels. Only the specific MU STA set as the representative may be set as the reception STA of the MU RTS frames 700 and 710 on the plurality of respective channels.

Each of the plurality of MU STAs representatively set as the reception STA by the MU RTS frames 700 and 710 may transmit the MU CTS frames 720 and 730 through the plurality of respective channels. As another expression, only the specific MU STA representatively set as the reception STA of the MU RTS frames 700 and 710 among the plurality of MU STAs that will receive the DM frames through the plurality of respective channels may transmit the CTS frames 720 and 730 on the plurality of respective channels.

Further, as described above, the bits corresponding to the MSB and the MSB-1 of the RA fields of the MU RTS frames 700 and 710 may be set to ‘11’.

In detail, in the RA field of MU RTS frame 1 700, MU STA 1 and MU STA 3 may be set as the reception STA and since the RA field of MU RTS frame 2 710 is the duplicate format of MU RTS frame 1, MU STA 1 and MU STA 3 may be similarly set as the reception STA.

MU STA 1 and MU STA 3 indicated as the reception STA by the MU RTS frame 1 700/MU RTS frame 2 710 may transmit the MU CTS frames 720 and 730, respectively. MU STA 1 may transmit MU CTS frame 1 720 through channel 1 and MU STA 3 may transmit MU CTS frame 2 730 through channel 2.

Information on the transmission channels of the MU CTS frames 720 and 730 of respective MU STA 1 and MU STA 3 may be implicitly determined based on an order of an identifier of MU STA 1 and an identifier of MU STA 3 included in the RA1 (AID) field and the RA2 (AID) field, respectively. Alternatively, the transmission channels of the MU CTS frames 720 and 730 of respective MU STA 1 and MU STA 3 may be determined based on uplink transmission resource allocation information for each STA, which is included in the MU RTS frames 700 and 710. Alternatively, MU STA 1 and MU STA 3 may transmit the MU CTS frames 720 and 730 through the primary channels of MU STA 1 and MU STA 3, respectively. UL STA 1 and MU STA 3 may transmit MU CTS frame 1 720 and MU CTS frame 2 730, respectively through the UL MU PPDU based on the UL MU transmission.

Since the plurality of MU STAs transmits the plurality of MU CTS frames 720 and 730, a protection range may be larger than the protection range at the time of transmitting the legacy RTS frame/legacy CTS frame in the related art.

The legacy STA and the MU STA other than MU STA 1 and MU STA 3, which receive the MU RTS frames 700 and 710/MU CTS frames 720 and 730 may configure the NAV during the MU TXOP set based on the duration fields of the MU RTS frames 700 and 710/MU CTS frames 720 and 730 and the channel access may be restricted on the set duration. Even when the NAV is configured, the STA/MU STA may monitor the frames transmitted from the AP to the STA/MU STA.

The MU AP that acquires the UL TXOP based on the MU RTS frames 700 and 710 and the MU CTS frames 720 and 730 may transmit the DL MU PPDU 740 including DL frame 1 and DL frame 2 to each of MU STA 1 and MU STA 2 through channel 1 based on the DL MU transmission and transmit the DL MU PPDU 750 including DL frame 3 and DL frame 4 to each of MU STA 3 and MU STA 4 through channel 2 based on the DL MU transmission. The DL MU PPDUs 740 and 750 transmitted through channels 1 and 2 may be one DL MU PPDU. Even when the NAV is configured, MU STA 2 and MU STA 4 may monitor and receive the downlink frame transmitted from the AP to MU STA 2 and MU STA 4.

MU STA 1 and MU STA 2 may transmit the block ACK 760 as the responses to DL frame 1 and DL frame 2 through channel 1 and MU STA 3 and MU STA 4 may transmit a block ACK 770 as the responses to DL frame 3 and DL frame 4 through channel 2.

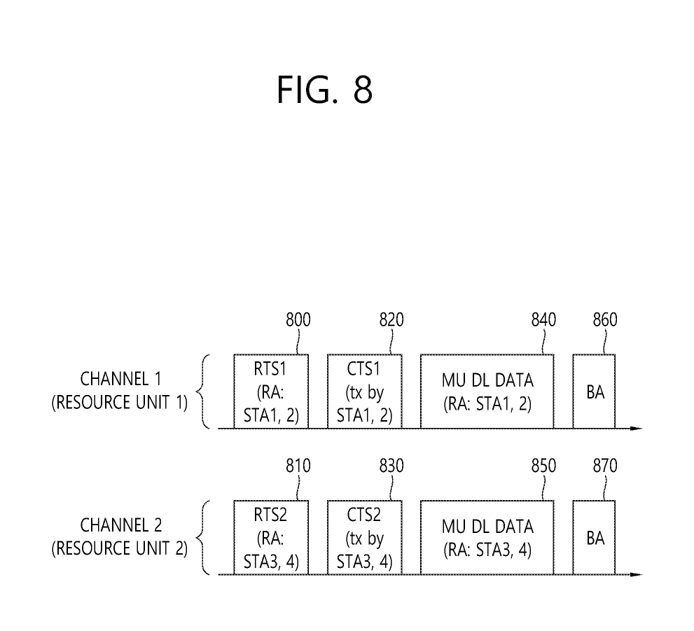

FIG. 8 is a conceptual view illustrating a transmission method of an MU RTS frame/MU CTS frame according to an embodiment of the present invention.

In FIG. 8, a method for protecting the MU TXOP based on transmission of the MU RTS frame of the MU AP and transmission of the MU CTS frame of the STA is disclosed.

Referring to FIG. 8, the AP may transmit a DL MU PPDU 840 including DL frame 1 and DL frame 2 based on the DL MU transmission to each of MU STA 1 and MU STA 2 through channel 1 and transmit a DL MU PPDU 850 including DL frame 3 and DL frame 4 to MU STA 3 and MU STA 4, respectively through channel 2 based on the DL MU transmission similarly to FIG. 7. The DL MU PPDUs transmitted through channels 1 and 2 may be one DL MU PPDU.

In order to acquire the MU TXOP for transmitting the DL MU PPDU, the AP may transmit MU RTS frame 1 800 through channel 1 and transmit MU RTS frame 2 810 through channel 2 based on the DL MU transmission. MU RTS frame 1 800 and MU RTS frame 2 810 may be transferred to a plurality of MU STAs through one DL MU PPDU on channel 1 and channel 2, respectively.

The RA field of each of the plurality of MU RTS frames 800 and 810 transmitted through the plurality of respective channels may include the identification information of the MU STA that will receive the DL frame through each of the plurality of channels.

For example, the RA field of MU RTS frame 1 800 may include the identification information (e.g., AID) of MU STA 1 and MU STA 2 that will receive DL frame 1 and DL frame 2 through channel 1. Further, the RA field of MU RTS frame 1 810 may include the identification information (e.g., AID) of MU STA 3 and MU STA 4 that will receive DL frame 3 and DL frame 4 through channel 2.

The MU STAs that receive the MU RTS frames 800 and 810 may transmit MU CTS frames 820 and 830 on the channels that receive the MU RTS frames 800 and 810. For example, each of MU STA 1 and MU STA 2 may transmit MU CTS frame 1 820 through channel 1 and each of MU STA 3 and MU STA 4 may transmit MU CTS frame 2 830 through channel 2.

As the number of MU STAs that transmit the MU CTS frames 820 and 830 increases, the transmission ranges of the MU CTS frames 820 and 830 may increase and the MU TXOP may be more effectively protected.

The legacy STA and the MU STAs other than MU STA 1 and MU STA 3 that receive the MU RTS frames 800 and 810/MU CTS frames 820 and 830 may configure the NAV during the MU TXOP set based on the duration fields of the MU RTS frames 800 and 810/MU CTS frames 820 and 830 and be switched to a doze state.

The MU AP that acquires the UL TXOP based on the MU RTS frames 800 and 810 and the MU CTS frames 820 and 830 may transmit the DL MU PPDU 840 including DL frame 1 and DL frame 2 to each of MU STA 1 and MU STA 2 through channel 1 based on the DL MU transmission and transmit the DL MU PPDU 850 including DL frame 3 and DL frame 4 to each of MU STA 3 and MU STA 4 through channel 2 based on the DL MU transmission. The DL MU PPDUs transmitted through channels 1 and 2 may be one DL MU PPDU.

MU STA 1 and MU STA 2 may transmit a block ACK 860 as the responses to DL frame 1 and DL frame 2 through channel 1 and MU STA 3 and MU STA 4 may transmit a block ACK 870 as the responses to DL frame 3 and DL frame 4 through channel 2.

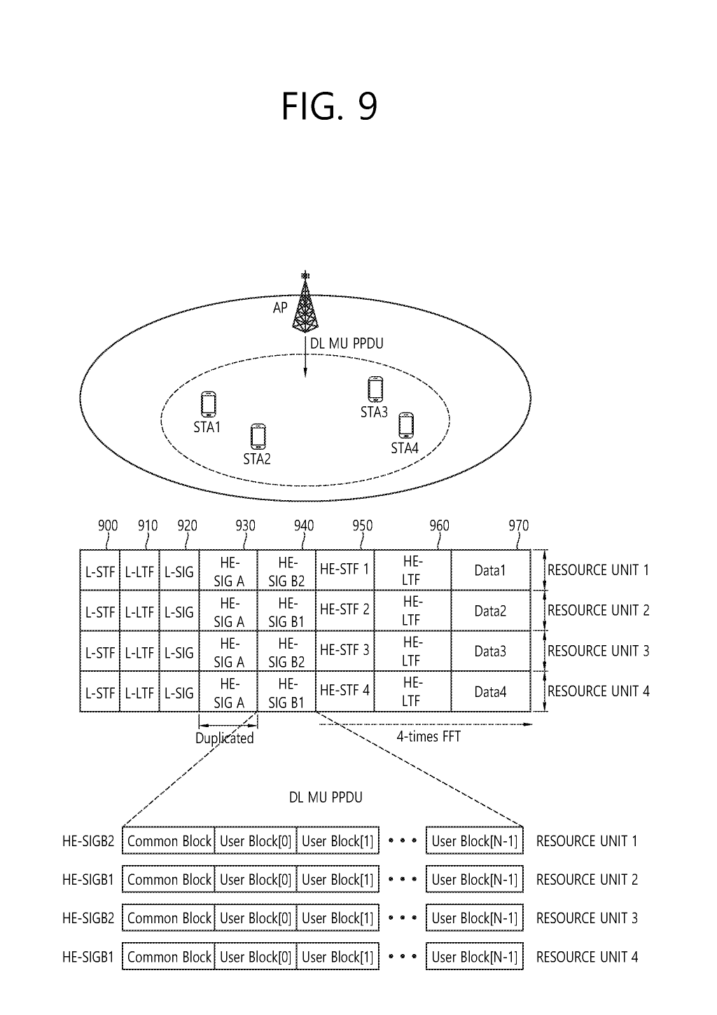

FIG. 9 is a conceptual view illustrating a format of a DL MU PPDU according to an embodiment of the present invention.

In FIG. 9, the format of the DL MU PPDU format transmitted based on the OFDMA by the AP according to the embodiment of the present invention is disclosed. The DL MU PPDU format may be implemented to transfer the plurality of RTS frames/the plurality of data frames in FIGS. 7 and 8 through the data field.

Referring to FIG. 9, the PPDU header of the DL MU PPDU may include a legacy-short training field (L-STF), a legacy-long training field (L-LTF), a legacy-signal (L-SIG), a high efficiency-signal A (HE-SIG A), a high efficiency-signal-B (HE-SIG B), a high efficiency-short training field (HE-STF), a high efficiency-long training field (HE-LTF), and the data field (alternatively, MAC payload). The PPDU header may be divided into a legacy part from the PHY header to the L-SIG and a high-efficiency part (HE part) after the L-SIG.

The L-STF 900 may include a short training orthogonal frequency division multiplexing (OFDM) symbol. The L-STF 900 may be used for frame detection, automatic gain control (AGC), diversity detection, and coarse frequency/time synchronization.

The L-STF 910 may include a long training orthogonal frequency division multiplexing (OFDM) symbol. The L-LTF 910 may be used for fine frequency/time synchronization and channel prediction.

The L-SIG 920 may be used for transmitting control information. The L-SIG 920 may include information on data rate and a data length.

The HE-SIG A 930 may include information for indicating the STA that will receive the DL MU PPDU. For example, the HE-SIG A 1230 may include information for indicating the identifier of a specific STA (alternatively, AP) that will receive the PPDU and a group of the specific STA. Further, the HE-SIG A 1230 may include even resource allocation information for the STA to receive the DL MU PPDU when the DL MU PPDU is transmitted based on the OFDMA or MIMO.

In addition, the HE-SIG A 930 may include color bits information, bandwidth information, the tail bit, a CRC bit, modulation and coding scheme (MCS) information for the HE-SIG B 1240, symbol number information for the HE-SIG B 940, and cyclic prefix (CP) (alternatively, guard interval (GI)) length information.

The HE-SIG B 940 may include the information on the length MCS and the tail bit of the physical layer service data unit (PSDU) for each STA. Further, the HE-SIG B 940 may include information on the STA that will receive the PPDU and OFDM based resource allocation information (alternatively, MU-MIMO information). When the OFDM based resource allocation information (alternatively, MU-MIMO related information) is included in the HE-SIG B 940, the resource allocation information may not be included in the HE-SIG A 930.

For example, the HE-SIG A 930/HE-SIG B 940 of the PPDU (alternatively, DL MU PPDU) that transfers a trigger frame for triggering the buffer state information and the downlink frame including report request information may include the resource allocation information for each of the plurality of uplink frames for transmitting the buffer state information of each of the plurality of STA.

The previous field of the HE-SIG B 940 on the DL MU PPDU may be transmitted in a duplicated form in each of different transmission resources. In the case of the HE-SIG B 940, the HE-SIG B 940 transmitted in some resource units (e.g., resource unit 1 and resource unit 2) is an independent field including individual information and the HE-SIG B 940 transmitted in the remaining resource units (e.g., resource unit 3 and resource unit 4) may be a format acquired by duplicating the HE-SIG B 940 transmitted in different resource units (e.g., resource unit 1 and resource unit 2). Alternatively, the HE-SIG B 940 may be transmitted in a form in which the HE-SIG B 940 is encoded in all transmission resources. The field after the HE-SIG B 940 may include the individual information for each of the plurality of STAs that receives the PPDU.

The HE-STF 950 may be used for enhancing automatic gain control estimation in a multiple input multiple output (MIMO) environment or OFDMA environment.

In detail, STA 1 may receive HE-STF 1 transmitted from the AP through resource unit 1 and decode data field 1 by performing synchronization, channel tracking/prediction, and AGC. Similarly, STA 2 may receive HE-STF 2 transmitted from the AP through resource unit 2 and decode data field 2 by performing the synchronization, the channel tracking/prediction, and the AGC. STA 3 may receive HE-STF 3 transmitted from the AP through resource unit 3 and decode data field 1 by performing the synchronization, the channel tracking/prediction, and the AGC. STA 4 may receive HE-STF 4 transmitted from the AP through resource unit 4 and decode data field 4 by performing the synchronization, the channel tracking/prediction, and the AGC.

The HE-LTF 960 may be used for estimating the channel in the MIMO environment or OFDMA environment.

The size of the IFFT applied to the HE-STF 950 and the field after the HE-STF 950 and the size of the IFFT applied to the field before the HE-STF 950 may be different from each other. For example, the size of the IFFT applied to the HE-STF 950 and the field after the HE-STF 950 may be four times larger than the size of the IFFT applied to the field before the HE-STF 950. The STA may receive the HE-SIG A 930 and may be instructed to receive the downlink PPDU based on the HE-SIG A 930. In this case, the STA may perform decoding based on the FFT size changed from the field after the HE-STF 950 and the HE-STF 950. On the contrary, when the STA may not be instructed to receive the downlink PPDU based on the HE-SIG A 930, the STA may stop decoding and configure the network allocation vector (NAV). The cyclic prefix (CP) of the HE-STF 950 may have a larger size than the CPs of other fields and during the CP interval, the STA may decode the downlink PPDU by changing the FFT size.

The access point (AP) may allocate a plurality of respective radio resources for a plurality of respective stations (STAs), respectively on the whole bandwidth and transmit the physical protocol data unit (PPDU) to the plurality of respective STAs through the plurality of respective radio resources. Information on allocation of the plurality of respective radio resources to the plurality of respective STAs may be included in the HE-SIG A 950 or the HE-SIG B 960 as described above.

In this case, each of the plurality of radio resources may be a combination of the plurality of radio resource units (BTU and STU) defined with different sizes on a frequency axis. As described above, the resource allocation combination may be a combination of one or more resource units which may be allocated on all available tones depending on the size of the bandwidth.

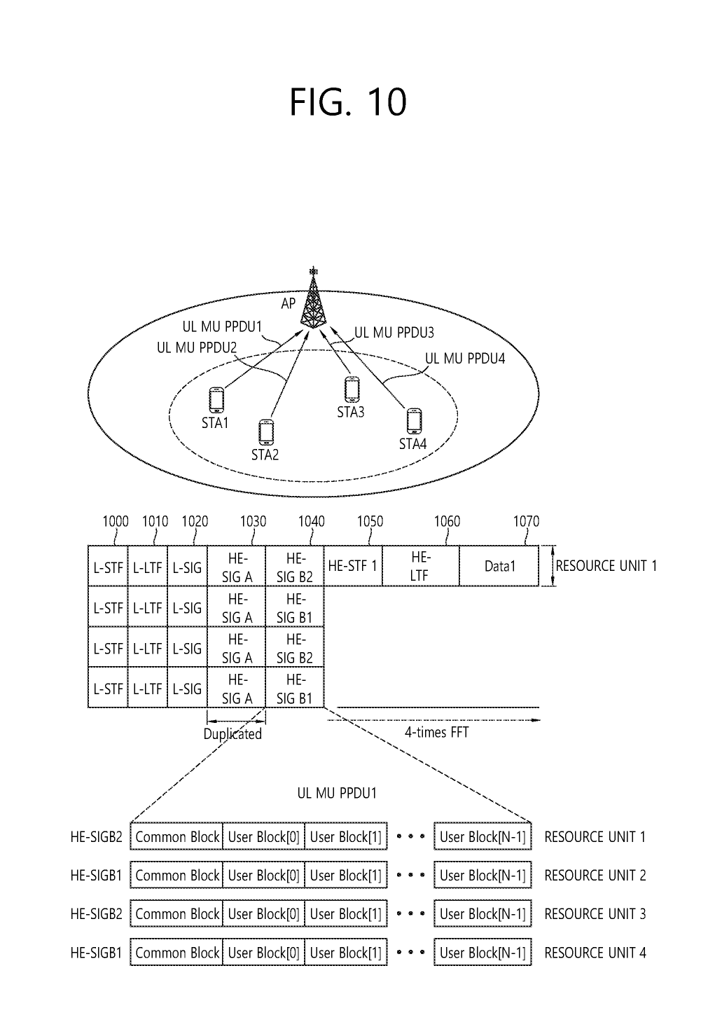

FIG. 10 is a conceptual view illustrating a format of a UL MU PPDU according to an embodiment of the present invention.

Referring to FIG. 10, the plurality of STAs may transmit the UL MU PPDU to the AP based on the UL MU OFDMA. The CTS frame/BA frame described above in FIGS. 7 and 8 may be transferred through the data field of the UL MU PPDU.

An L-STF 1000, an L-LTF 1010, an L-SIG 1020, an HE-SIG A 1030, and an HE-SIG B 1040 may play roles disclosed in FIG. 9. Information included in signal fields (the L-SIG 1020, the HE-SIG A 1030, and the HE-SIG B 1040) may be generated based on the information included in the signal field of the received DL MU PPDU.

STA 1 may perform uplink transmission through the whole bandwidth up to the HE-SIG B 1040 and perform the uplink transmission through the allocated bandwidth after the HE-STF 1050. STA 1 may transfer the uplink frame through the allocated bandwidth (e.g., resource unit 1) based on the UL MU PPDU. The AP may allocate the uplink resource of each of the plurality of STAs based on the DL MU PPDU (e.g., HE-SIG A/B) and each of the plurality of STAs may be allocated with the uplink resource and transmit the UL MU PPDU.

As described above, each of the plurality of STAs may transmit the buffer state information and the block ACK related information through the control field of the MAC header included in the data field or an MAC frame body.

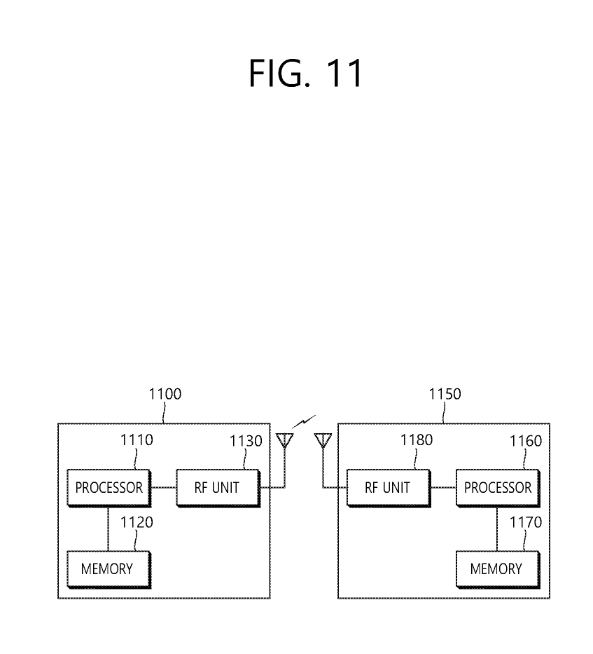

FIG. 11 is a block diagram illustrating a wireless apparatus to which an embodiment of the present invention can be applied.

Referring to FIG. 11, the wireless apparatus 1100 as an STA that may implement the aforementioned embodiment may be an AP 1100 or a non-AP station (alternatively, STA) 1150.

The AP 1100 includes a processor 1110, a memory 1120, and a radio frequency (RF) unit 1130.

The RF unit 1130 is connected with the processor 1110 to transmit/receive a radio signal.

The processor 1110 may implement a function, a process, and/or a method proposed in the present invention. For example, the processor 1110 may implemented to perform the operation of the AP according to the embodiment of the present invention. The processor may perform the operations of the AP disclosed in the embodiments of FIGS. 1 to 10.

For example, the processor 1110 may be implemented to transmit the MU RTS frame to the medium in order to protect the MU TXOP. The MU frame may include the RA field, the RA field may include the RA control field and the plurality of RA simple identification fields, the RA control field may include the information indicating that the RTS frame is the MU RTS frame transmitted to acquire the MU TXOP, and each of the plurality of RA simple identification field may include the identification information of each of the plurality of STAs.

The STA 1150 includes a processor 1160, a memory 1170, and a radio frequency (RF) unit 1180.

The RF unit 1180 is connected with the processor 1160 to transmit/receive the radio signal.

The processor 1160 may implement a function, a process, and/or a method proposed in the present invention. For example, the processor 1160 may implemented to perform the operation of the STA according to the embodiment of the present invention. The processor may perform the operations of the STA disclosed in the embodiments of FIGS. 1 to 10.

For example, the processor 1160 may be implemented to receive the RTS frame transmitted based on the DL MU transmission by the AP and determine whether to configure the NAV based on the RA field of the RTS frame and when the RTS frame is the MU RTS frame for acquiring the MU TXOP, the RA field may include the RA control field and the plurality of RA simple identification fields, the MU TXOP may indicate the time resource having the transmission right for the DL MU transmission of the downlink data, the RA control field may include the information indicating that the RTS frame is the MU RTS frame transmitted to acquire the MU TXOP, and each of the plurality of RA simple identification field may include the identification information of each of the plurality of STAs.

The RA control field may include the transmission type information, the identifier type information, and the receiver number information and the transmission type information may indicate whether the transmission type is unicast or multicast, the identifier type information may indicate whether the identifier type is globally unique or locally administrated, and the reception STA number information may include the information on the number of the plurality of STAs. When the value of the transmission type information is set to the first value and the value of the identifier type information is set to the second value, it may be indicated that the RTS frame is the MU RTS frame.

The processor 1160 may be implemented to configure the NAV when the value of the transmission type information is set to the first value and the value of the identifier type information is set to the second value and transmit the MU CTS frame for protecting the MU TXOP to the AP based on the UL MU transmission without configuring the NAV when the STA is the MU STA that supports the MU transmission, the value of the transmission type information is set to the first value, the value of the identifier type information is set to the second value, and the plurality of RA simple identification fields indicates the STA.

The processor 1160 may be implemented to receive the downlink frame transmitted based on the DL MU transmission by the AP after transmitting the MU CTS frame and transmit the block acknowledgement (BA) frame to the AP based on the UL MU transmission as the response to the downlink frame.

The processors 1110 and 1160 may include an application-specific integrated circuit (ASIC), another chipset, a logic circuit, a data processing device and/or a converter converting a baseband signal and the radio signal into each other. The memories 1120 and 1170 may include a read-only memory (ROM), a random access memory (RAM), a flash memory, a memory card, a storage medium, and/or other storage devices. The RF units 1130 and 1180 may include one or more antennas that transmit and/or receive the radio signal.

When the embodiment is implemented by software, the aforementioned technique may be implemented by a module (a process, a function, and the like) that performs the aforementioned function. The software code may be stored in the memories 1120 and 1170 and executed by the processors 1110 and 1160. The memories 1120 and 1170 may be positioned inside or outside the processors 1110 and 1160 and connected with the processors 1110 and 1160 by various well-known means.

What is claimed is:

1. A medium protecting method for multi-user (MU) transmission in a wireless LAN, comprising:
receiving, by an STA, an RTS frame transmitted on the basis of DL MU transmission by an AP; and
determining, by the STA, whether to configure an NAV on the basis of an RA field of the RTS frame,
wherein if the RTS frame is an MU RTS frame for acquiring MU TXOP, the RA field includes an RA control field and a plurality of RA simple identification fields,
the MU TXOP indicates a time resource having a transmission right for DL MU transmission of downlink data,
the RA control field includes information for indicating that the RTS frame is an MU RTS frame transmitted to acquire the MU TXOP, and
each of the plurality of RA simple identification fields can include identification information of each of the plurality of STAs.

2. The method of claim 1, wherein the RA control field includes transmissions type information, identifier type information, and reception STA number information,
the transmission type information indicates whether a transmission type is unicast or multicast,
the identifier type information indicates whether an identifier type is globally unique or locally administrated,
the reception STA number information includes information on the number of the plurality of STAs, and
when a value of the transmission type information is set to a first value and the value of the identifier type information is set to a second value, it is indicated that the RTS frame is the MU RTS frame.

3. The method of claim 1, wherein the determining of whether to configure the NAV includes
configuring, by the STA, the NAV when the STA is a legacy STA that does not support the MU transmission, the value of the transmission type information is set to the first value, and the value of the identifier type information is set to the second value, and
transmitting, by the STA, an MU CTS frame for protecting the MU TXOP to the AP based on the UL MU transmission without configuring the NAV when the STA is the MU STA that supports the MU transmission, the value of the transmission type information is set to the first value, the value of the identifier type information is set to the second value, and the plurality of RS simple identification fields indicates the STA.

4. The method of claim 3, further comprising:
receiving, by the STA, a downlink frame transmitted based on DL MU transmission by the AP after transmitting the MU CTS frame; and
transmitting, by the STA, a block acknowledgement (BA) frame to the AP based on the UL MU transmission as a response to the downlink frame.

5. A station (STA) for performing medium protection for multi-user (MU) transmission in a wireless LAN, comprising:
a radio frequency (RF) unit transmitting and receiving a radio signal; and
a processor operatively coupled with the RF unit,
wherein the processor is implemented to
receive a request to send (RTS) frame transmitted on the basis of downlink (DL) multi-user (MU) transmission by an AP, and
determine whether to configure a network allocation vector (NAV) on the basis of a receiver address (RA) field of the RTS frame,
if the RTS frame is an MU RTS frame for acquiring transmission opportunity (MU TXOP), the RA field includes an RA control field and a plurality of RA simple identification fields,
the MU TXOP indicates a time resource having a transmission right for DL MU transmission of downlink data,
the RA control field includes information for indicating that the RTS frame is an MU RTS frame transmitted to acquire the MU TXOP, and
each of the plurality of RA simple identification fields can include identification information of each of the plurality of STAs.

6. The STA of claim 5, wherein the RA control field includes transmissions type information, identifier type information, and reception STA number information,
the transmission type information indicates whether a transmission type is unicast or multicast,
the identifier type information indicates whether an identifier type is globally unique or locally administrated,
the reception STA number information includes information on the number of the plurality of STAs, and
when a value of the transmission type information is set to a first value and the value of the identifier type information is set to a second value, it is indicated that the RTS frame is the MU RTS frame.

7. The STA of claim 5, wherein the processor is implemented to
configure the NAV when the STA is a legacy STA that does not support the MU transmission, the value of the transmission type information is set to the first value, and the value of the identifier type information is set to the second value, and
transmit an MU CTS frame for protecting the MU TXOP to the AP based on the UL MU transmission without configuring the NAV when the STA is the MU STA that supports the MU transmission, the value of the transmission type information is set to the first value, the value of the identifier type information is set to the second value, and the plurality of RS simple identification fields indicates the STA.

8. The STA of claim 7, wherein the processor is implemented to
receive a downlink frame transmitted based on DL MU transmission by the AP after transmitting the MU CTS frame, and
Transmit a block acknowledgement (BA) frame to the AP based on the UL MU transmission as a response to the downlink frame.
